(19) United States
(12) Patent Application Publication
(10) Pub. No.: US 2011/0276336 A1
(43) Pub. Date: Nov. 10, 2011

(54) METHOD AND APPARATUS FOR MANAGING PRODUCTION COMPLEXITY OF HIGH YIELD, MULTIPLE CROP GARDENING AND SUSTAINABLE FARMING OPERATIONS

(75) Inventor: Tracy Sweely, Lafayette, CO (US)

(73) Assignee: Tracy Sweely, Lafayette, CO (US)

(21) Appl. No.: 13/070,756

(22) Filed: Mar. 24, 2011

Related U.S. Application Data
(60) Provisional application No. 61/317,480, filed on Mar. 25, 2010.

(51) Int. Cl. G06Q 50/00

(52) U.S. Cl. 705/1.1

(57) ABSTRACT

The presented inventions provide systems and methods (i.e. utilities) in which cultivators of varying skill-levels use a web-based application or software, to manage the complexity involved in planning and implementation of annual production of high-yields of multiple crops over time for a specific number of consumers and/or to fulfill specific retail and/or wholesale sales projections.

### CROSS REFERENCE

The application claims the benefit of the filing date of U.S. Provisional Application No. 61/317,480 entitled “METHOD AND APPARATUS FOR MANAGING PRODUCTION COMPLEXITY OF HIGH YIELD MULTIPLE CROP GARDENING AND SUSTAINABLE FARMING OPERATIONS” and having a filing date of Mar. 25, 2010, the entire contents of which are incorporated herein by reference.

### BACKGROUND OF THE INVENTION

One outcome of market trends in the United States towards localization of the food industry has been a significant rise in participation in backyard gardening and sustainable farming. A National Gardening Association 2009 study called “The Impact of Home and Community Gardening in America, reports that 43 million US households intend to grow produce in 2009. Of that figure, 21 percent will be new gardeners. Likewise, there has been similar increases in sustainable, non-industrial multi-crop farming operations as indicated by tremendous consumer driven growth in direct marketing avenues for sustainably grown produce such as Farmers Markets, wholesale markets (e.g. to restaurants) and Community Supported Agriculture (CSA) programs. According to USDA statistics the number of Farmers Markets in the US has steadily increased by a total of 300% between 1994 and 2009. In addition the number of small-farms participating in Farmers Markets has increased with a Crossroads Resource Center study indicating a 17% increase within the 5-year period between 2002 and 2007.

CSA's are a membership based, pre-paid, direct purchase model of agricultural produce distribution used virtually exclusively by sustainable farming operations. In 1999 the Center for Integrated Agricultural Systems found only about 1000 farms operating CSA's. Seven years later in 2007 a US Department of Agriculture census found 12,459 farms operating CSA's. Thus the number of such entities has increased by 1200% in 7 years. While the actual number of such sustainable farming operations has increased, existing operations have also seen significant growth. A survey conducted by the University of Kentucky Cooperative Extension in 2009 found that of the farms operating Community Supported Agriculture programs, memberships in these programs have increased 50% between 2007 and 2009.

While these statistics demonstrate tremendous growth in the local food production industry, standardization of sustainable farming methods and techniques has been lacking. Both quantity and variety in crops are desirable at the backyard gardening and sustainable farming levels, yet regardless of agricultural techniques achieving an optimal and predictable balance for household use or for direct marketing at Farmers Markets, wholesale markets and to CSA members throughout the growing season is an exceptionally complex endeavor. In a 2001 survey conducted by the Center for Integrated Agricultural Systems, information and knowledge acquisition for those participating in CSAs is dependent upon information sharing within the industry. A cursory web survey of gardening information websites demonstrates a similar situation. While there are an increasing number of web-based information “clearing houses” providing general methodological and technical information for gardeners and sustainable farmers, no systematic methodological apparatus has been developed for managing the complexities encountered in consistent and predictable, maximum-yield production of multiple crops over an entire growing season.

### SUMMARY OF INVENTION

One specific problem faced by gardeners and farmers (i.e. cultivators) of multiple crops is in the difficulty in coordinating crop yields over time. Stated otherwise, it is often desirable to set a production goal that may be tied to output volumes/desired yields (e.g, weight, sales value, etc.) for one or more crops to be harvested on several specific dates during the harvest season. However, many cultivators do not have the ability to quickly and easily translate such production goals into planning requirements for multiple crops or multiple harvests of one crop. For example, a cultivator may desire to harvest 300 lbs of 10 different varieties of carrots each week over the course of 12 weeks, with each variety having a different maturation time. Another cultivator may desire to harvest 30 lbs of carrots every other week for 6 weeks, 20 lbs of radishes every other week for 4 weeks and 10 lbs of lettuce every week for 8 weeks. Another cultivator may desire some combination of the previous two goals. Regardless, most cultivators lack the ability to quickly and easily determine how many plants or how large of an area needs to be planted in these crops and when each crop or variety needs to be planted in order to generate such a desired yield. Furthermore, different cultivation methods tend to result in different yields. For example, bio-intensive methods utilize dense planting techniques that tend to increase the yield of crops in relation to, for example, more traditional planting techniques Likewise, the present inventor has also recognized that the skill level of the cultivators also affect crop yields. For instance, a highly experienced cultivator (e.g., experienced gardener or professional farmer) using bio-intensive methods may achieve yields four times greater than those of a novice bio-intensive cultivator and up to twice that of a bio-intensive cultivator of moderate experience. Accordingly, when generating a plan that relates planting requirements to desired yields, it is important to account for the variations in cultivator skill and cultivation method in order to more accurately determine the planting requirements to produce the desired yield. Various aspects of the presented inventions are premised on these recognitions. Further, the various aspects of the presented inventions may be provided as stand-alone software provided on computer readable media that contains executable logic that allows a processor to provide the functionality described herein. In other arrangements, the inventions may be provided in a web-based environment. Such an arrangement, processing may be distributed amongst different servers and/or client devices. In any aspect, processing of the various outputs may also include accessing third party databases to obtain additional input information.

According to one aspect, a utility is provided that allows for generating planting requirements necessary to generate desired crop yields for one or more cultivated crops. The utility includes receiving inputs from a requesting user that include cultivation information of the requesting user (e.g., skill level, cultivation methods, etc.), an identification of one or more crops to be raised in a cultivation area and a desired yield for each of the crops at specific times during the harvest season. Based on these inputs, a crop yield database may be accessed to obtain expected crop yield information for each of the identified crops. Such database information may include yield information (e.g. average yields) for the identified crops. Such crop yield information may be adjusted based on the cultivation information provided by the requesting user. Further, such information may be indexed to different cultivation methods. Other indexing categorizations are possible (e.g., geographic area). Based on the expected crop yield information and inputs received from the user, the utility generates a planting plan that includes at least a schedule for planting one or more crops and a planting requirement for generating the desired crop yield. In a distributed utility, (e.g., web-based) the method may further include transmitting the planting plan or requesting user via a data network.

The schedule for planting the crop will typically include one or more planting dates for each crop and/or one or more harvest dates for each crop. In various arrangements, each crop may include a plurality of planting dates and a plurality of harvest dates. In such arrangements, the crops may be succession planted (e.g., planted each week for several weeks, including planting a crop in a location of a previous crop after harvest, and planting different varieties of one crop with different maturation times each week over several weeks).

In a further arrangement, the planting dates planting schedule may be based at least in part on a last expected frost date for a geographical region associated with the requesting user. Further, the planting schedule may be based in part on a maturity duration of the planted crops. Such information may be received from the user or such information may be acquired from stored data. In one arrangement, upon obtaining a geographic input from the requesting user (manually or automatically), the utility may further include accessing at least one database to obtain information for the geographic area or region associated with the cultivation area of the requesting user. Such information may include, without limitation, frost date information, soil type information for the geographic area and/or climate information for the geographical area. Climate information may include, without limitation, average rain fall and/or average temperatures during the growing season. Accordingly, this information may be utilized to further modify the crop yield information and thereby modify the planting requirements for each desired crop yield.

As noted above, the planting requirements typically provide planting information for achieving a desired yield for each crop. However, this planting requirement may be provided in a number of different ways. According to a first arrangement, the planting requirement provides a number of plants of each crop required to generate the desired crop yield. In another arrangement, a total number of seeds of the crop are provided. In a further arrangement, a weight of the seeds required to generate the desired crop yield provided. In a yet further embodiment, cultivation area is provided. In this latter embodiment, the total area of planting space (e.g. row length) may be provided based, for example, on the planting density of the cultivation method implemented by the user. In an arrangement that provides row length, it will be appreciated that row length indicates a total linear measure but does not require that the planted area be in a linear row or consecutive plants in a single row.

In a further aspect, the utility allows for determining if a cultivation area contains adequate space to produce the desired crop yield. In such an arrangement, the utility further includes receiving an input indicative of a size of a cultivation area. Furthermore, this aspect requires determining space requirement versus the desired yield and generating an output that indicates that space is available or that space is not available to achieve the desired yield of one or more crops. Upon determining space is not available, the utility may further adjust (automatically or prompt a user) the desired yield of one or more crops until the planting requirements (e.g., planting space) is equal to or less than the size of the cultivation area.

In another aspect, a utility is provided that allows for planning multiple plantings and harvests of a single or multiple crops. In this arrangement, the utility includes receiving cultivation information of the requesting user and identification of one or more crops to be raised in a cultivation area as well as the number of desired harvests and crop yields per harvest for those crops. The utility accesses a crop yield database to obtain expected crop yield information for the crop and processes the yield information in conjunction with the user input to produce a planting schedule that includes a schedule for planting each harvest of each crop as well as expected harvest for each crop. Furthermore, each crop will include at least first and second planting dates that allows for successive harvests and/or succession harvests where a subsequent harvest is planted in a location of previous harvest. Such functionality allows for cultivators to more continuously harvest produce from their cultivated areas.

In a further aspect, the utility may receive feedback from one or more users. This feedback may be incorporated in to data (e.g., yield information) subsequently utilized to generate outputs. For instance, actual crop yields for a geographic region received at the end of a harvest for a first season or planting may be utilized to predict crop yields for a second season or planting. For instance, actual crop yields achieved by users within a specific skill level received at the end of a harvest for a first season or planning may be utilized to refine predictions of crop yields for subsequent seasons or plantings that could be achieved by other users within that skill level and within that geographic region.

### BRIEF DESCRIPTION OF DRAWINGS

For a more complete understanding of the present invention, and further advantages thereof, reference is now made to the following detailed description taken in conjunction with the drawings in which:

FIG. 1 is a schematic diagram illustrating a web-based application for the management of production complexity of high-yield, multiple crop, gardening and sustainable farming operations in accordance with the present invention; and

FIG. 2 illustrates the user interface screen for entering basic information.

FIG. 3 illustrates a cold weather crop input screen.

FIG. 4 illustrates a hot weather crop input screen.

FIG. 5 illustrates a retail sales input screen.

FIG. 6 illustrates a hot weather crop planting requirement.

FIG. 7 illustrates a cold weather crop planting requirement.

FIG. 8 illustrates a cold weather crop planting schedule.

FIG. 9 illustrates a hot weather crop planting schedule.

FIG. 10 illustrates seed requirement schedules.

FIG. 11 illustrates an exemplary crop rotation template.

FIG. 12 illustrates a planting schedule overview.

FIG. 13 illustrates a planting and harvest guide for succession crops.

FIG. 14 illustrates a planting harvest guide for hot weather crops.

FIG. 15 illustrates one process implemented by the present utility.

FIG. 16 illustrates another process implemented by the present utility.

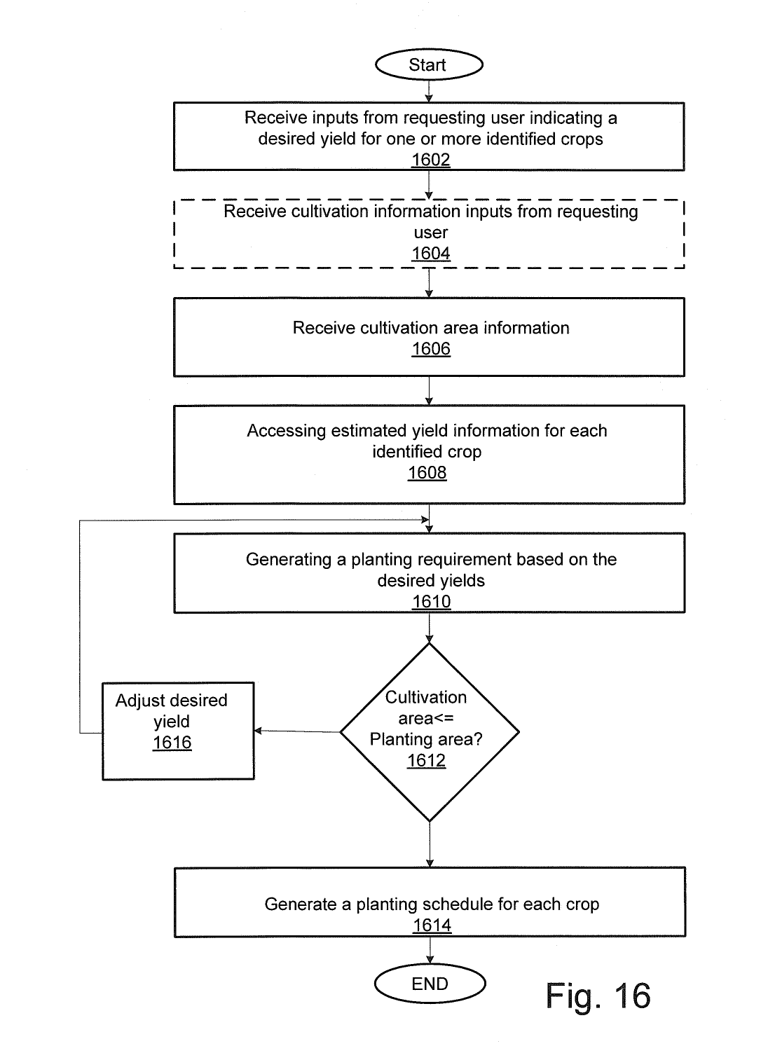

### DETAILED DESCRIPTION

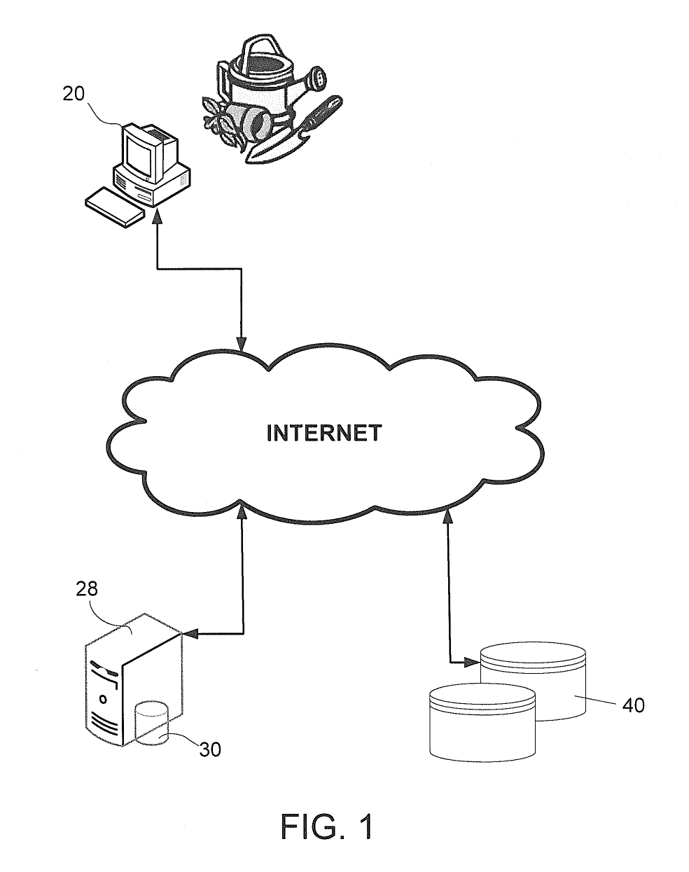

The present inventions provide systems and methods (i.e. utilities) in which cultivators of varying skill-levels use a web-based application or software, to manage the complexity involved in planning and implementation of annual production of high-yields of multiple crops over time for a specific number of consumers and/or to fulfill specific retail and/or wholesale sales projections. One embodiment of a web-based version of such a system is depicted in FIG. 1.

FIG. 1 shows a network that includes various computers and databases linked via the Internet. A client computer 20 using a Web browser (e.g., “Internet Explorer” by the Microsoft Corporation) may access the Internet via one or more Internet Service Providers. In the present embodiment, the client computer 20 accesses a website hosted by a server (or collection of servers) 28 and database 30. The database 30 may include various related date including, without limitation, maturation durations for various crops, estimated yields (e.g. per plant, per planted area, etc.) for various crops and/or crop classification information (e.g. hot weather vs. cold weather crops).

The client located at, for instance, their cultivation location (e.g., farm or garden) may access various web pages provided by the server 28 to enter various information associated with their garden/farm as described below. The information entered into these web pages is then processed to provide desired cultivation information as described below. Such processing may occur at the server, at a remote computer/processing platform and/or at the client computer.

In any arrangement, it will be appreciated that the processing computer(s) and/or various servers and databases may each include one or more processors or processing units, system memory, and a bus that couples various system components including the system memory to the processor(s). The system memory may include read only memory (ROM) and random access memory (RAM). A basic input/output system (BIOS) containing the basic routines that help to transfer information between elements within computer, such as during start-up, is stored in ROM. These devices may also include internal memory such as a hard disk drive, a magnetic disk drive, and/or an optical disk drive for reading from or writing to a removable optical disk such as a CD ROM, DVD ROM or other optical media. These drives are each connected to a bus by one or more interfaces.

The drives and their associated computer-readable media provide nonvolatile storage of computer readable instructions, data structures, program modules, and other data for the various computers, servers. A number of program modules may be stored on the hard disk, magnetic disk, optical disk, ROM, or RAM, including an operating system, one or more application programs (such as a Web browser), other program modules, and programs and data associated with the utility described herein. In this latter regard, it will be appreciated that aspects of the utility may be variously incorporated into software, hardware and firmware. Further, while being described herein primarily as a web-based application, it will be appreciated that aspects of the utility may be incorporated into software provided on removable media (e.g., CD ROM) for stand-alone use.

A user may enter commands and information into the client computer through input devices such as keyboard and pointing device. Other input devices (not shown) may include a microphone, scanner, or the like. A monitor or other type of display device is also connected to the. In addition to the monitor, personal computers typically include other peripheral output devices (not shown) such as speakers and printers.

In operation, the user can access the web pages located on the server and provide requested information in order to obtain, inter alia, planting schedules, harvesting schedules, estimated yields and supporting information (e.g., amount of seeds, preferred sunlight areas, watering needs for each crop, etc.). Once the user has entered the necessary information, the utility processes this information to provide the desired information. In addition to processing the information entered by the user, the processing of the information may include accessing one or more internal databases and/or third party databases 40. Such third party databases may provide additional information for use in calculating one or more of the desired outputs. For instance, such third party databases may include, without limitation, USGS databases which may provide, inter alia, soil information associated with the location of the requesting user. Other databases may provide information regarding local weather conditions, precipitation etc.

Cultivators such as backyard gardeners and sustainable farmers relying on direct marketing models, tend to be producing crops for a specific number of consumers, whether these consumers are simply family members or CSA members, or for the purpose of achieving a specific retail sales goal through sales at Farmers Markets or wholesale markets. Both types of cultivators desire to maintain predictability, consistency and high yields for as many varieties of crops as possible. Doing so requires extended foresight and planning of the entire growing season based on varying spatial requirements and coordination of the varying maturation periods of different crops and different crop varieties. Most cultivators lack the time and expertise to design a specific data management system for cultivation purposes in order to manage the complexity involved in this type of growing. Instead cultivators tend to use cumbersome manual methods, such as plotting out successive crops on roles of butcher paper or on stacks of 3×5 cards. Many simply avoid the complexity and settle for a level of predictability, consistency, quantity and variety, far below what their cultivation area is capable of.

While there are programs that assist cultivators in planning their gardens and farms, virtually all are oriented towards the “plan view” component of such planning, i.e. plotting out bed/row planting layouts. While some of these programs enable cultivators to record their production plans on the layouts, none provide automation of the coordination of spatial planting requirements and maturation periods for all crops, based upon quantity and variety goals for the growing season.

The present inventions are directed to methods and apparatuses (i.e., utilities) for managing the complexity of cultivating a specific quantity (e.g. desired yield) and variety of produce for a specific number of consumers and/or to achieve specific retail and/or wholesale sales goals during a growing season. The utilities are operative to receive any of a number of various inputs and use these inputs to provide, inter alia, planting and harvesting schedules that allow cultivators to enhance their production and provide a more constant supply of crops from their garden or farm. For instance, given inputs including some or all of the following:

the number of consumers to be fed,

the amount of planting space available,

the environmental conditions distilled to the regional hardiness zone,

the harvest period end date,

the amount of each crop to be provided for each consumer per week,

the amount of produce to be sold in the retail sphere per week,

how many weeks each crop will be harvested,

the plant spacing for each crop,

and the retail prices of each crop if selling at Farmers Markets or wholesale markets,

The utilities output information about some or all of the following:

the amount of space to plant of each crop over the entire season,

the amount of space to plant of each crop each week,

when to plant each crop initially,

when to plant subsequent successions of each crop;

when harvests of each crop's successions are likely to begin,

when harvests of each crop's successions are likely to end,

how much seed (number and/or weight) for each crop will be needed to meet production goals,

and the projected income that could be generated from retail sales for each crop per week; for each crop per season and for all crops combined over the entire season.

One aspect of the presented inventions also tracks the cultivation area required for planting later season successions of the same crop in the same location as initial plantings and for intercropping (i.e. the planting of multiple crops with varying maturation times in the same location at the same time). Both of these techniques allow the variable of time to be used to “increase” the amount of available usable planting space.

Finally, an aspect of the presented inventions also provides a method, components of which may be automated, for translating output information to “on the ground” implementation.

As noted, the various aspects of the utilities may be provided as stand-alone software provided on computer readable media. In other arrangements, the utilities may be provided in a web-based environment. In such an arrangement, the web-based system may also include providing periodic reminders to a user where such reminders provide planting and/or harvest date information. Such reminders may be provided via a data network (e.g., e-mail) and/or a telephonic network (text message) or via any appropriate messaging system.

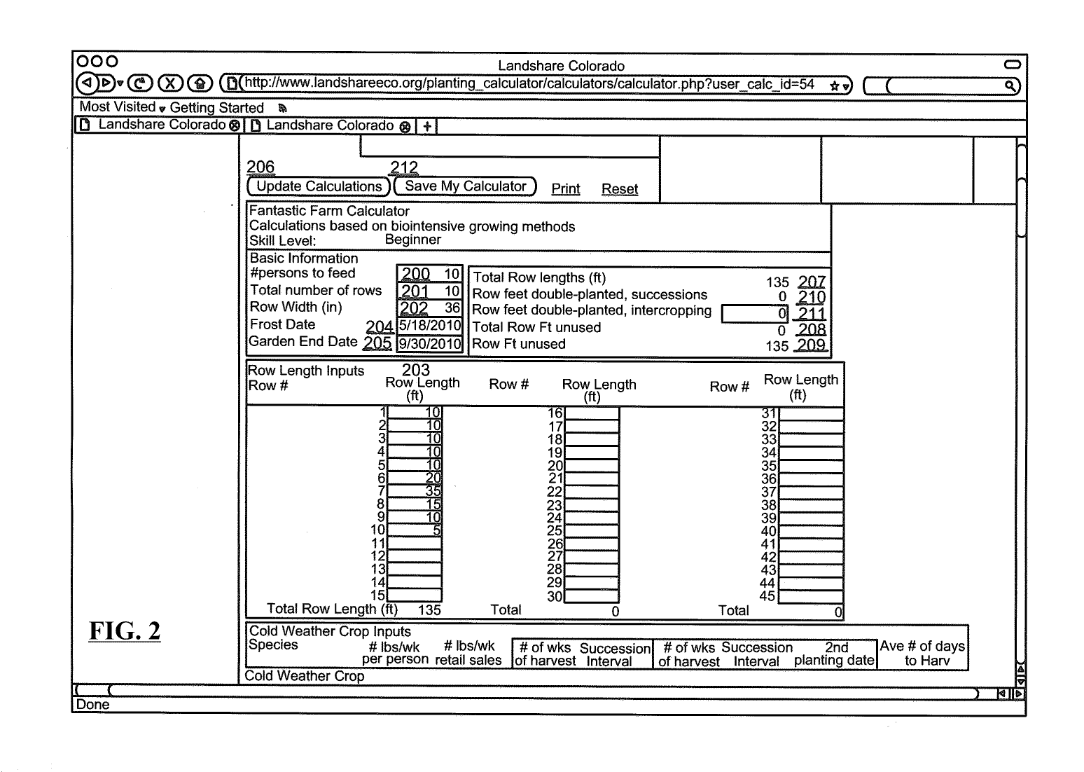

FIGS. 2-14 show a number of interface screens and templates that may be provided in connection with the utility, and illustrate a variety of associated functions. In this regard a user (i.e. a cultivator or an agent thereof) can choose a skill-level of the system that is appropriate to their agricultural experience and methods used. Skill-levels demonstrate a relationship between 1) experience, 2) methods used, and 3) a limited set of environmental conditions and anticipated yield per crop. Once the user chooses a skill-level, they manually input information regarding conditions of their agricultural operation, production goals, and/or retail and wholesale sales goals as illustrated in FIGS. 2, 3, 4 and 5.

In the interface illustrated in FIG. 2 a user inputs the conditions of their operation, referred to in the figure as Basic Information. Input fields include the number of consumers for which the user is attempting to provide, the amount of planting space they have 201, 202 and column 203, the final Frost Date in their region 204 (i.e. their hardiness zone) and their Garden End Date 205 (i.e. the date upon which they will harvest the last of the produce for the season). In a further arrangement, a user may provide a geographic input (e.g. zip code) such that the system may access stored data and retrieve such information. In one arrangement, the amount of planting space is set forth in row length (e.g., linear feet). That is, rather than calculating based on the individual area of a particular plot, the utility may make calculations based on a more simplified length measurement. By providing multiple harvests over a growing season, it will be appreciated that portions of the rows may be reused (e.g., late crops may replace earlier harvested crops). In this regard, the total calculated row length may exceed the actual available row length.

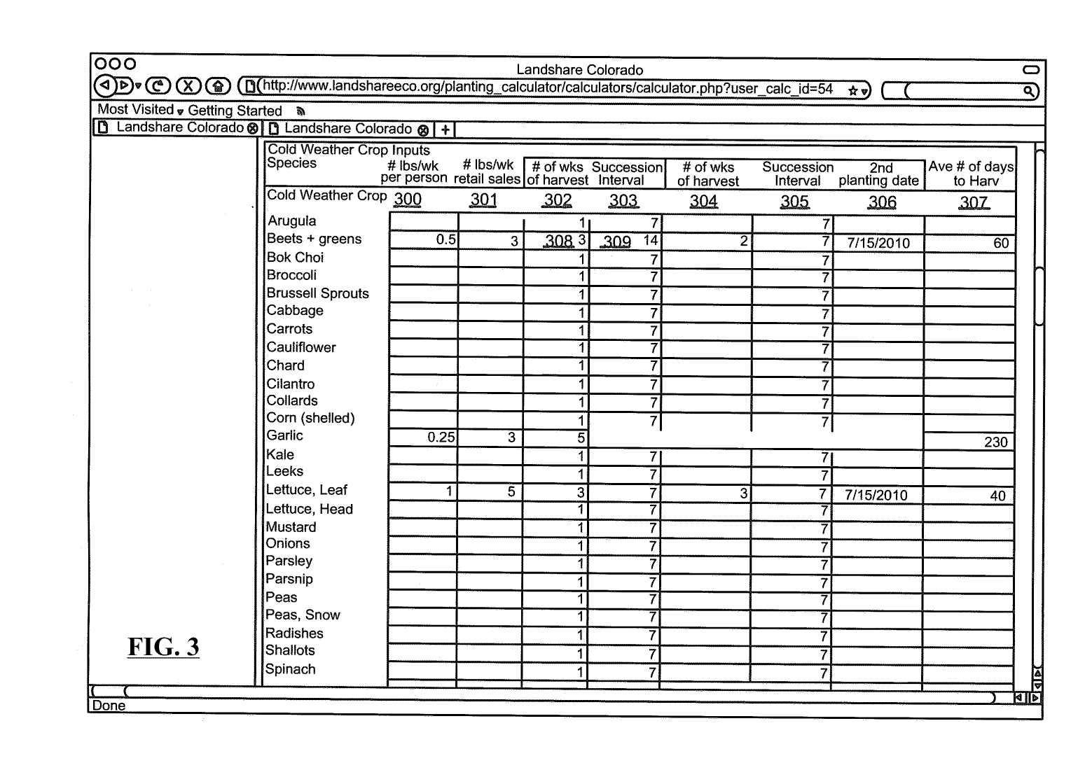

The illustrated system further allows the user to input information about their harvest goals. In the interface shown in FIG. 3, the user inputs information about their harvest goals for each of the crops that are succession planted that they intend to grow, referred to in the figure as Cold Weather Crop Inputs. Succession planting refers to multiple plantings of a single crop at different times (e.g., once a week for four weeks). Generally, cold weather crops better tolerate cooler weather and have short maturation times that allow for obtaining multiple harvests of a crop during a growing season. In this regard, a particular crop may be planted in the spring and harvested in the early summer. This same crop may also be replanted in the late summer and harvested in the fall. For instance, if a user desires to harvest leaf lettuce over an extended period, the user may plant different sets of seeds at different times. Thus, after the first set of seeds matures and is harvested, a second set of seeds/plants may shortly thereafter reach maturity and be harvested. Such succession planting provides a more continuous harvest of a crop. The user will input information on the number of lbs of each crop they intend to feed each consumer per week, column 300, and/or the number of lbs they intend to sell, column 301. The user will then input information on the number of successions they intend to harvest of each crop in the early part of the season column 302, and the interval at which said crops would be harvested, weekly or biweekly, column 303. The user will then input information on the number of successions they will harvest of each crop in the later part of the season column 304, and the interval at which said crops will be harvested, weekly or biweekly, column 305, and they will input the first planting date of the first crop succession planted in the later part of the season column 306. Finally, the user inputs the average number of days to maturity for the varieties of each crop they intend to grow column 307. Alternatively, the user may select crops they will grow and the utility will access average stored maturation information for each selected crop. It will be appreciated that crop maturation can vary significantly between varieties of a single crop. Therefore, a user may override such automatically populated entries.

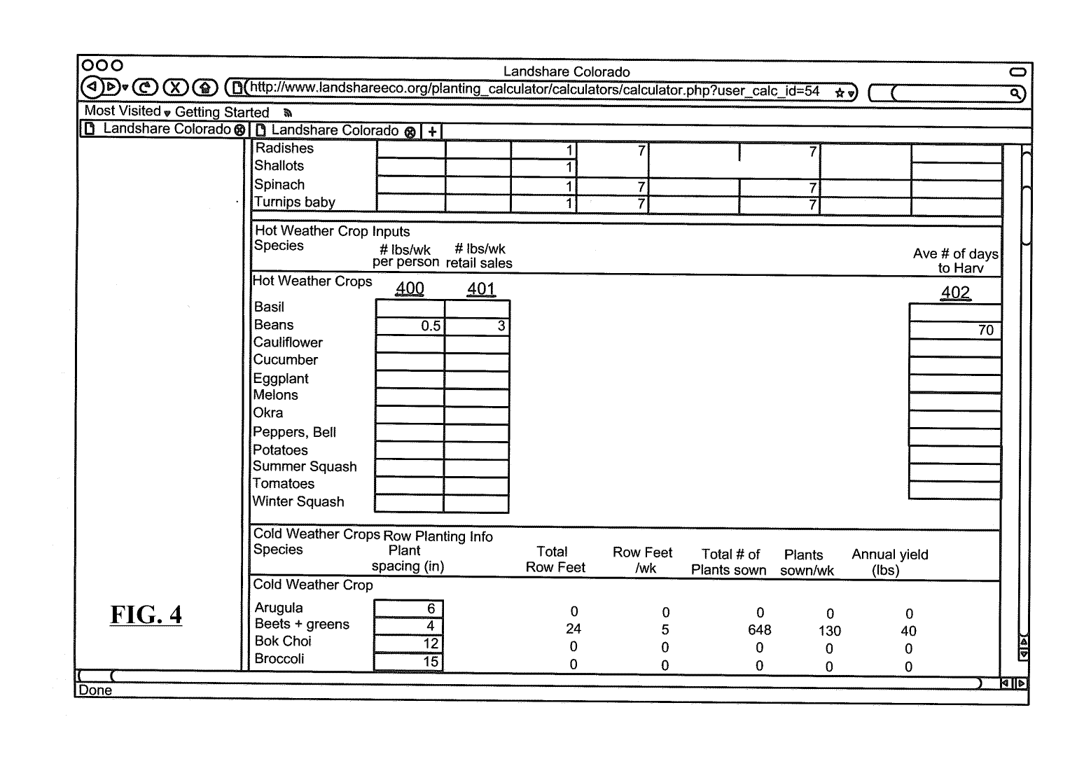

The interface shown in FIG. 4 illustrates how a user can input information about their harvest goals for each of the crops that are not succession planted that they intend to grow, referred to in the figure as Hot Weather Crop Inputs. Generally, such Hot Weather Crops require warmer soil temperatures and are, therefore, planted later in the growing season. In many cases, hot weather plants also have longer maturations. In either instance, Hot Weather Crops typically produce a single harvest during a growing season. The user will input information on the number of lbs of each crop they intend to feed each consumer per week column 400, and the number of lbs they intend to sell column 401. Finally, the user inputs the average number of days to maturity for the varieties of each crop they intend to grow column 402.

Based on all values input by the user the system performs calculations that allow the user to track how much space they have used. That is, the utility identifies the total yields and planting requirements (e.g. row feet) for the cold and hot weather crops to determine how much total row space is utilized. This is demonstrated in the interface shown in FIG. 2. Once the conditions of the operation and the harvest goal information are input, the user clicks on the “Update Calculations” tab 206 and outputs are generated for the total amount of planting space available 207, the total amount of planting space “used” 208 based on the harvest goals input in the interfaces in FIG. 3 and FIG. 4 and shows the user how much planting space they have remaining, 209. Field 209 also indicates if the user has input harvest goals that cause more planting space to be “used” than the cultivator has. In this case, the cultivator returns to the interfaces in FIG. 3 and FIG. 4 to make adjustments in cells in columns 300-307 and 400-402. Alternatively, the utility may automatically adjust some or all of the production goals to match the planting space available 207 to the planting space used 208. After changing any input fields the user always returns to 206 and clicks “Update Calculations” for any changes to be incorporated into the system. The interface also allows the user to save their inputs 212 so that they may be archived, used again or modified for subsequent growing seasons.

The illustrated system also allows the user to “save planting space” via succession planting and intercropping. Field 210 in FIG. 2 indicates to the user how much space they will save by planting later season crop successions in the same location as early season crop successions, after these early successions have been harvested. In addition, users can input the amount of space they are going to intercrop in field 211 and the system will incorporate the additional space saved, reducing the amount of planting space used 208 and increasing the amount of planting space remaining 209. After filling in any input fields the user always returns to 206 and clicks “Update Calculations” for any changes to be incorporated into the system.

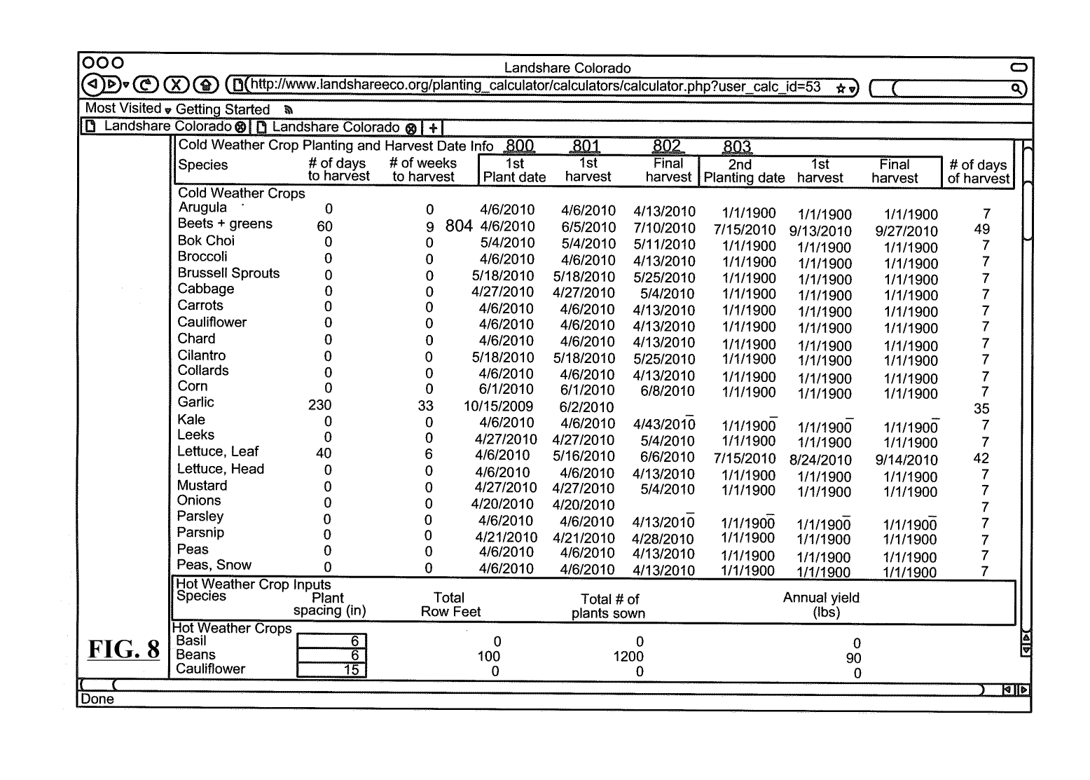

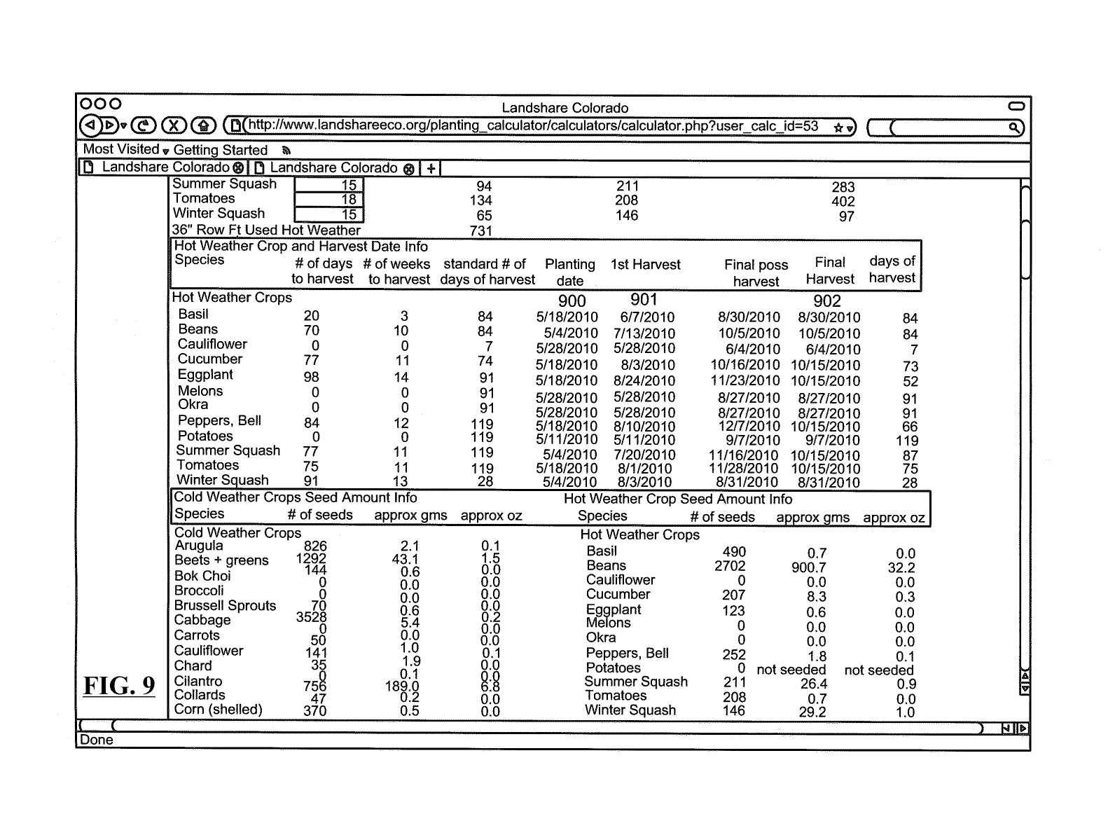

Based on the inputs, the system generates a planting and harvesting schedule as illustrated in FIG. 8. Users are able to check the outputs generated by the system as illustrated in FIG. 8 to make sure that the first planting date of later season successions input in 306 and replicated by the system in 803, does not conflict with dates generated by the system in 800, 801 and 802. As shown in entry 804 two successions of Beets and Greens are proposed. The first planting date 800 is April 6 for a harvest between June 5 and July 10, the final harvest 802. After the final harvest 802, a second succession of Beets and Greens is replanted 803 in this same row space for harvest between September 13 and September 27. This row space is utilized twice during the growing season allowing a user to “increase” the size of their garden by counting this space twice. FIG. 9 illustrates the planting 900 and harvest dates 901 for hot weather crops.

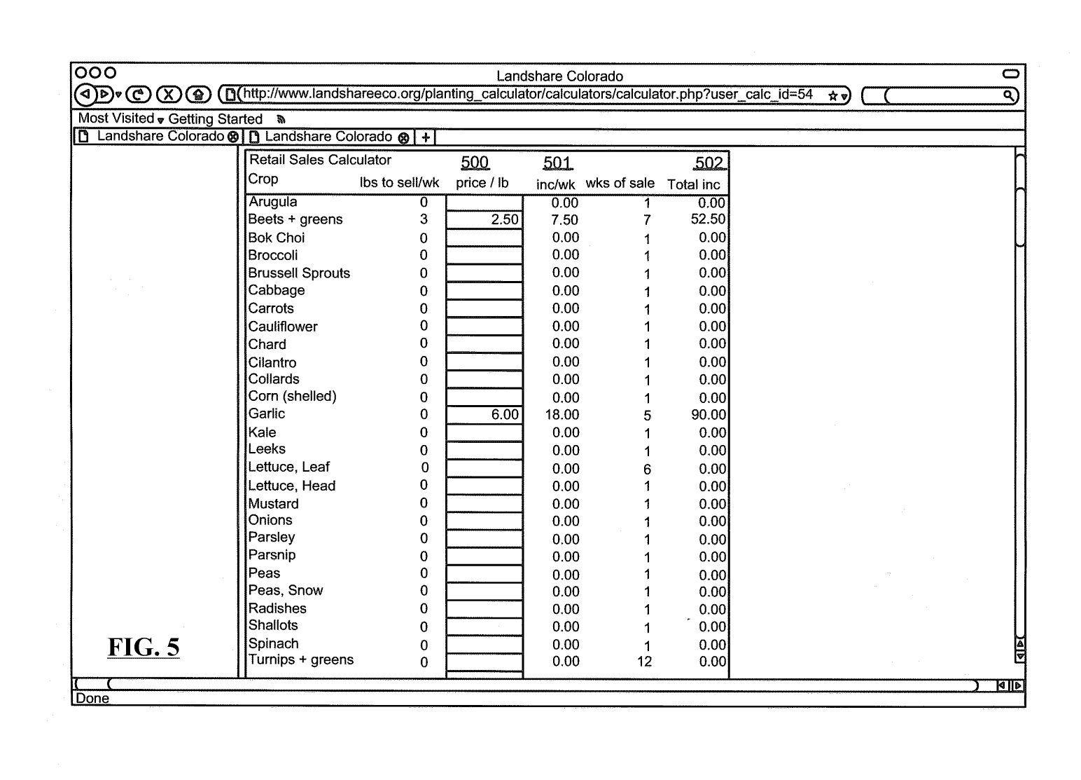

FIG. 5 illustrates an interface of the system in which the user can input information about intended prices for retail and/or wholesale sales. The input fields found in the column denoted by 500 are filled by the user with prices they intend to charge for each crop in retail and wholesale markets. Outputs generated by the system illustrated in FIG. 5 are based on the prices input in the column denoted by 500 and the harvest goals for retail and whole sales input in the interface in FIG. 3 and FIG. 4. These outputs include the projected amount of income per crop per week in column 501, per crop per season in column 502 and for all crops combined per season, not shown. After filling in any input fields the user always returns to 206 and clicks “Update Calculations” for any changes to be incorporated into the system. As will be appreciated, a user may also input a price goal for a crop and work backward through the process to determine planting requirements for the crop.

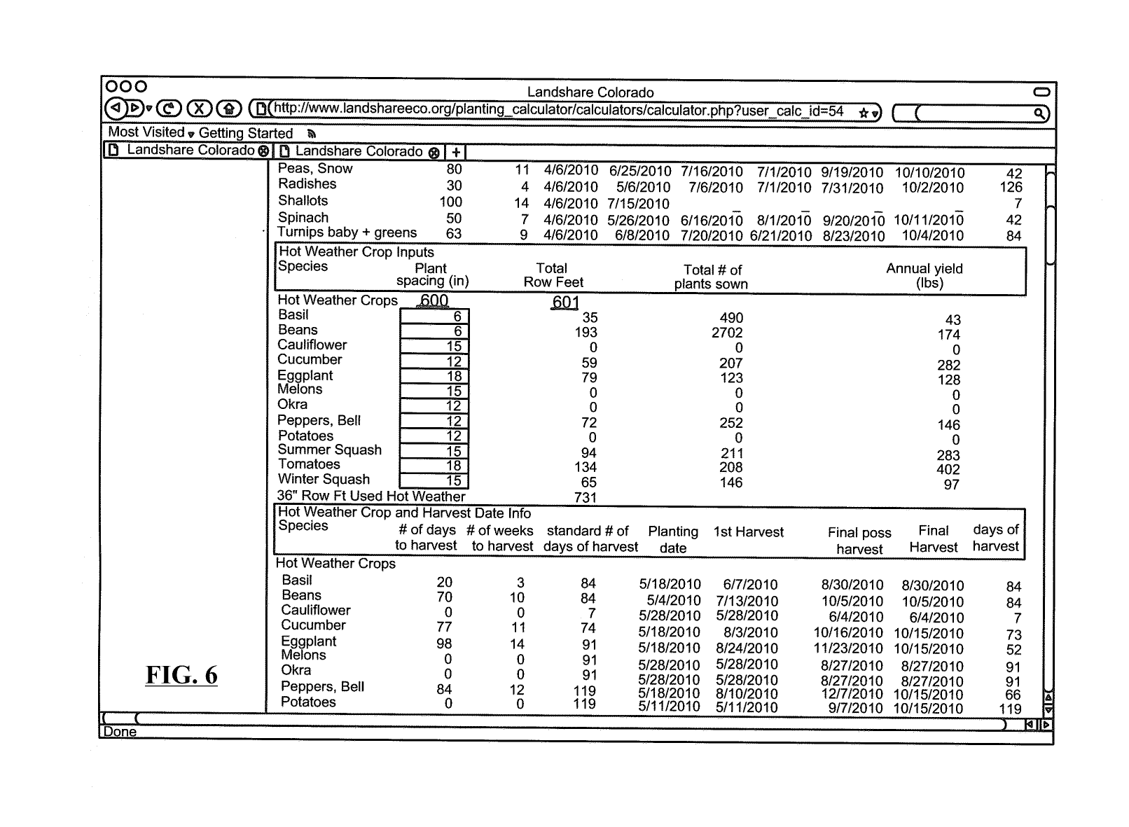

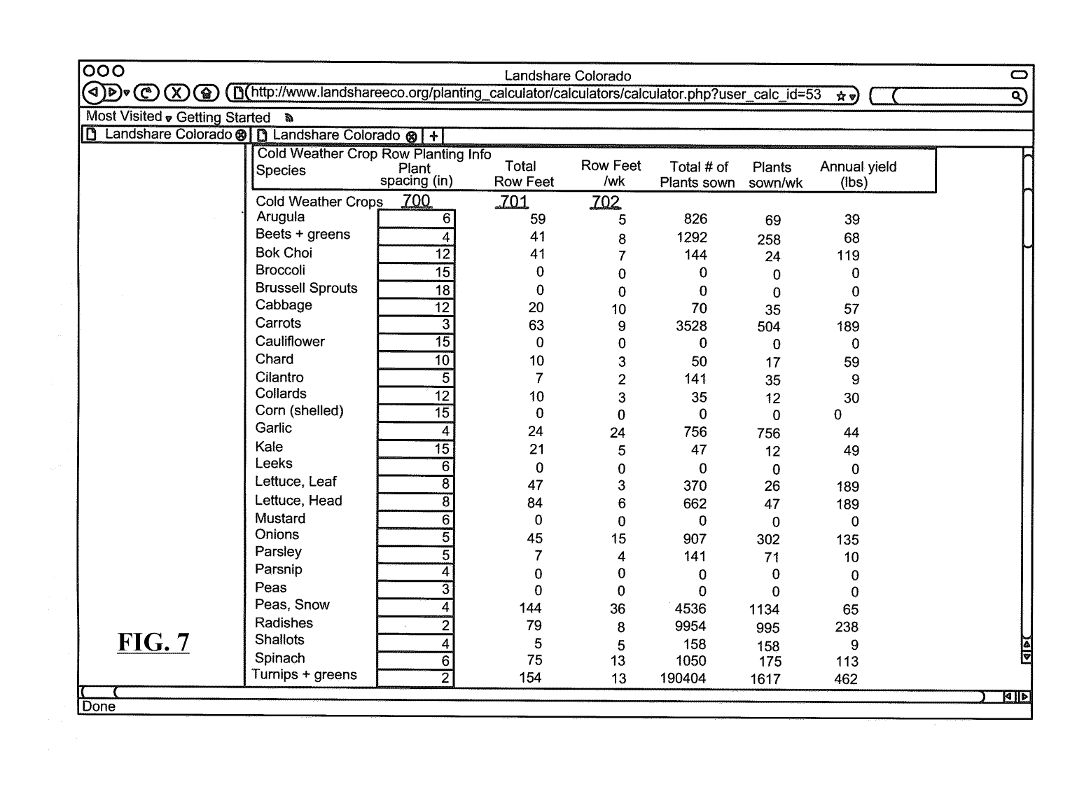

While the illustrated system was designed using bio-intensive agricultural methods that use the technique of close plant spacing, the system allows the user to employ other types of plant spacing techniques. Input fields in FIG. 6 and FIG. 7, in the columns denoted by 600 and 700 contain default plant spacing guidelines based on intensive cultivation techniques, but can be changed to accommodate any technique the user employs. Row Width in FIG. 2, entry 202, can also be changed to make such accommodations. Further, when prompted to input a skill level, a user may select another technique and these default spacing guidelines may be automatically updated. In any employed technique, the system identifies how much row space (i.e. a planting requirement) is necessary to achieve the desired output. Accordingly, users simply plant the necessary row length for each desired crop. While the present application provides a simplified output in row feet, it will be appreciated that a user may plant this total amount in separate rows in separate locations.

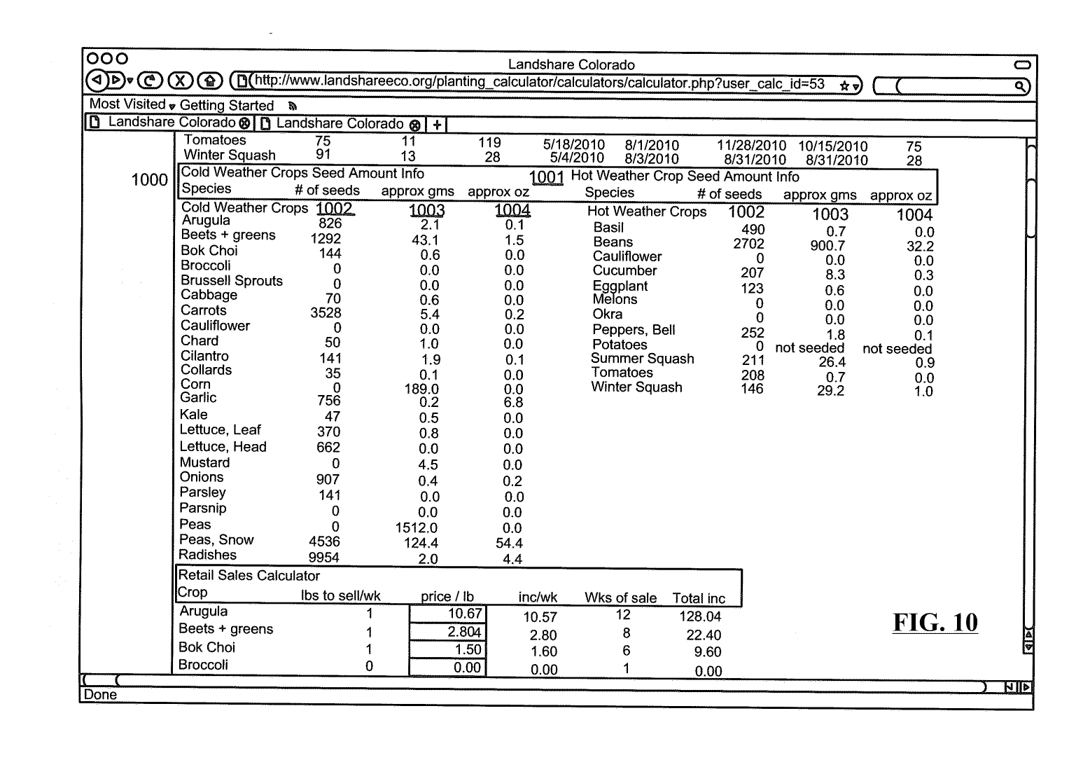

The system may also automatically generate the amount of seed the user will need to achieve their harvest goals as shown in FIG. 10 referred to in the screen 1000 as Cold Weather Crop Seed Amount Info and 1001 Hot Weather Crop Seed Amount Info. For each crop, the seed amount information is given in column 1002 number of seeds, column 1003 number of grams and column 1004 number of ounces. It will be appreciated that most seed packs vary in the amount of seeds contained therein. Therefore, it has been determined an easier way to determine the required amount of seed is via a weight measure rather than total seeds. In addition it will be appreciated that seed companies vary in the unit of measure that they provide on seed packs. Some will specify grams others ounces and some the actual number of seeds. Providing the user with seed quantities in varying units of measure prevents them from having to translate the units of measure.

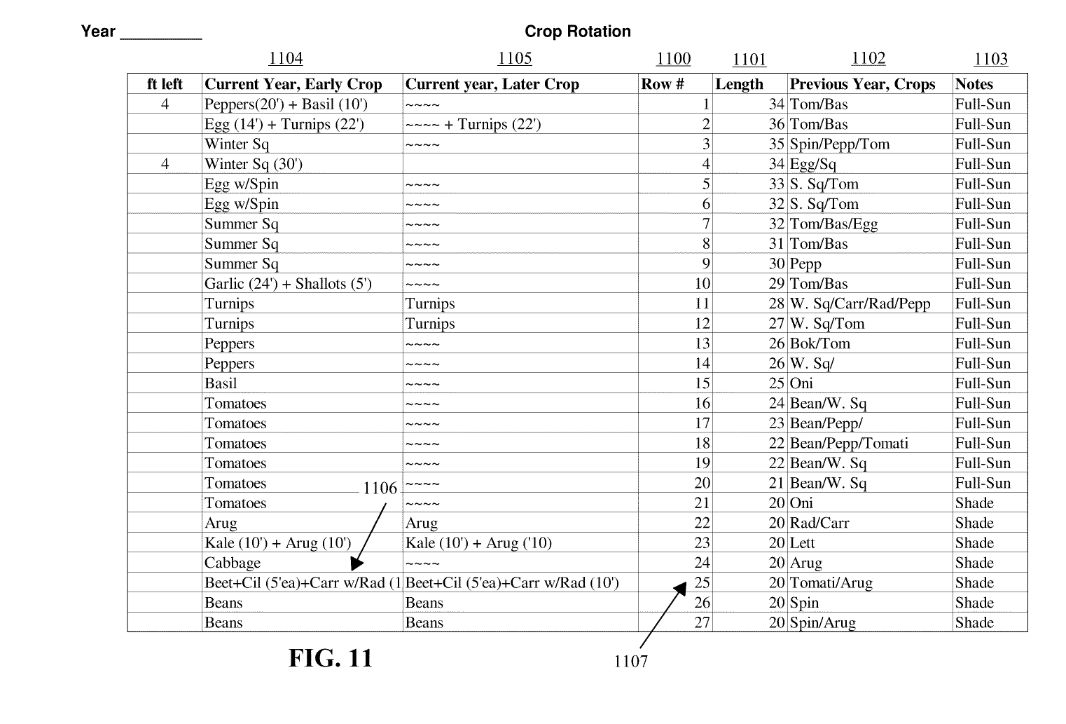

Once all harvest goal information is input and adjusted so that the user has “used” 208 as much of the available planting space as possible, output information shown in FIGS. 6, 7, 8 and 9 can automatically, or manually by the user, be translated into templates provided by the system shown in FIGS. 11, 12, 13 and 14 that are then used to implement plans “on the ground”.

The Crop Rotation Template shown in FIG. 11 is used to plan where current year crops will be planted. First, the user records in column 1100 each planting row designation, in column 1101 the length of the planting row, in column 1102 the previous year crop planted in each row, and in column 1103 pertinent notes about the conditions of each row, such as sun exposure. Then output information for the total amount of space planted for each crop from column 601 on the screen shown in FIG. 6, (referred to as Hot Weather Crop Row Planting Info in the screen), is used to assist the user in deciding where to plant crops that are not succession planted in the Crop Rotation Template shown in FIG. 11, column 1104. Next output information for the total amount of space planted for each crop from column 701 on the screen shown in FIG. 7 (referred to as Cold Weather Crop Row Planting Info in the screen), is used to assist the user in deciding where to plant crops that are succession planted in the Crop Rotation Template shown in FIG. 11, column 1104 for the initial plantings in the early part of the season and column 1105 for subsequent successions planted in the later part of the season. Plans to intercrop some crops will be reflected in columns 1104 and 1105. For example field 1106 demonstrates the intercropping of carrots with radishes.

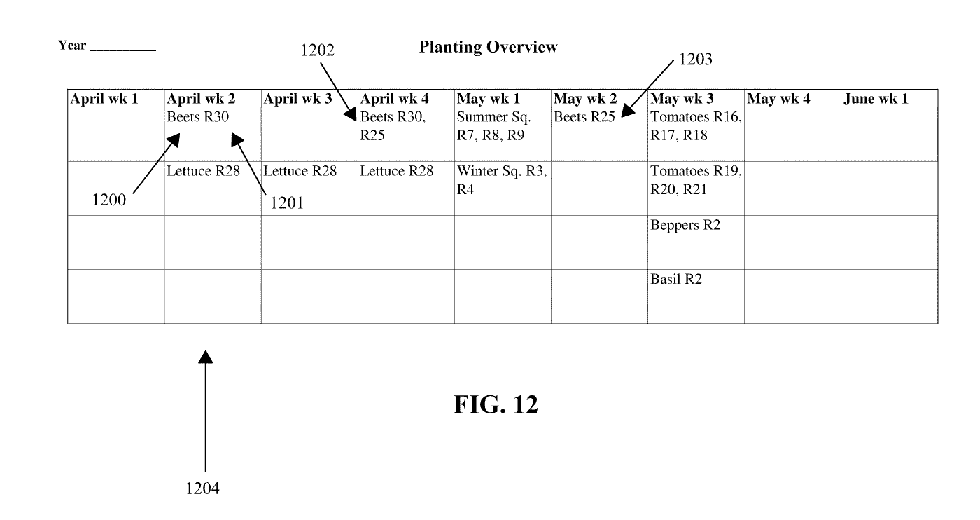

Once the Crop Rotation Template shown in FIG. 11 is completed, it is used along with output information from the screen shown in FIG. 8 (referred to as the Cold Weather Planting and Harvest Date Info on the screen), and output information from the screen shown in FIG. 9 (referred to as the Hot Weather Planting and Harvest Date Info on the screen), to fill in the Planting Overview template shown in FIG. 12.

Initial planting dates of both crops that are succession planted and that are not succession planted, are retrieved automatically, or manually by the user, from columns 800 and 900, respectively, and recorded in the appropriate field on the Planting Overview template shown in FIG. 12. For example, output information from the screen in FIG. 8, field 804, indicates that the initial planting of Beets is April 6^{th}. This information would be transferred automatically or manually by the user to the Planting Overview template shown in FIG. 12, in column 1204 indicating the 2^{nd} week of April, field 1200. From the Crop Rotation template shown in FIG. 11 a row designation 1107 for the initial planting of Beets will also be filled in, automatically or manually, in FIG. 12 the Planting Overview template field 1201.

Subsequent successive plantings of crops that are succession planted in both the early, column 800 and late part of the season, column 803, are also recorded in the Planting Overview shown in FIG. 12, based on the number of weeks of harvest and harvest interval input by the user in FIG. 3, columns 302 and 303, respectively, for the early part of the season and columns 304 and 305, respectively for the later part of the season. For example according to 308 in FIG. 3, there will be three successions of Beets in the early part of the season and they will be planted bi-weekly 309. The second and third successive plantings of Beets in the early part of the season would be recorded under the 4^{th} week of April 1202 and the 2nd week of May 1203. The first later season planting dates in column 803 for crops that are succession planted are also recorded in the appropriate field on the Planting Overview template shown in FIG. 12, not shown. The same basic automated or manual procedure is carried out for each crop for both early and later season successions until the Planting Overview template, FIG. 12, is completed.

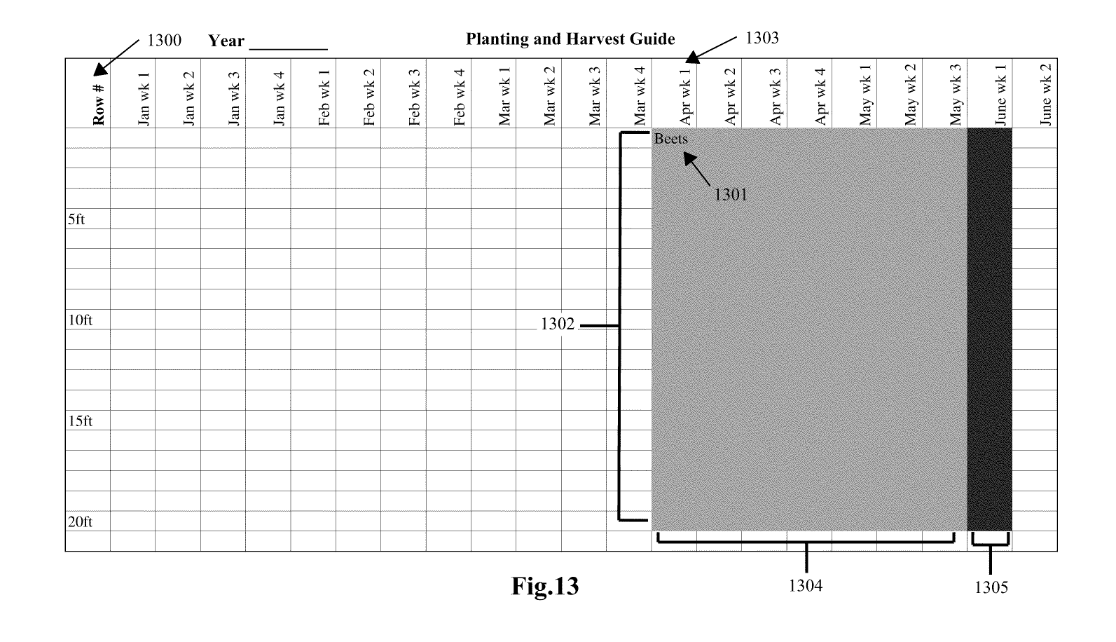

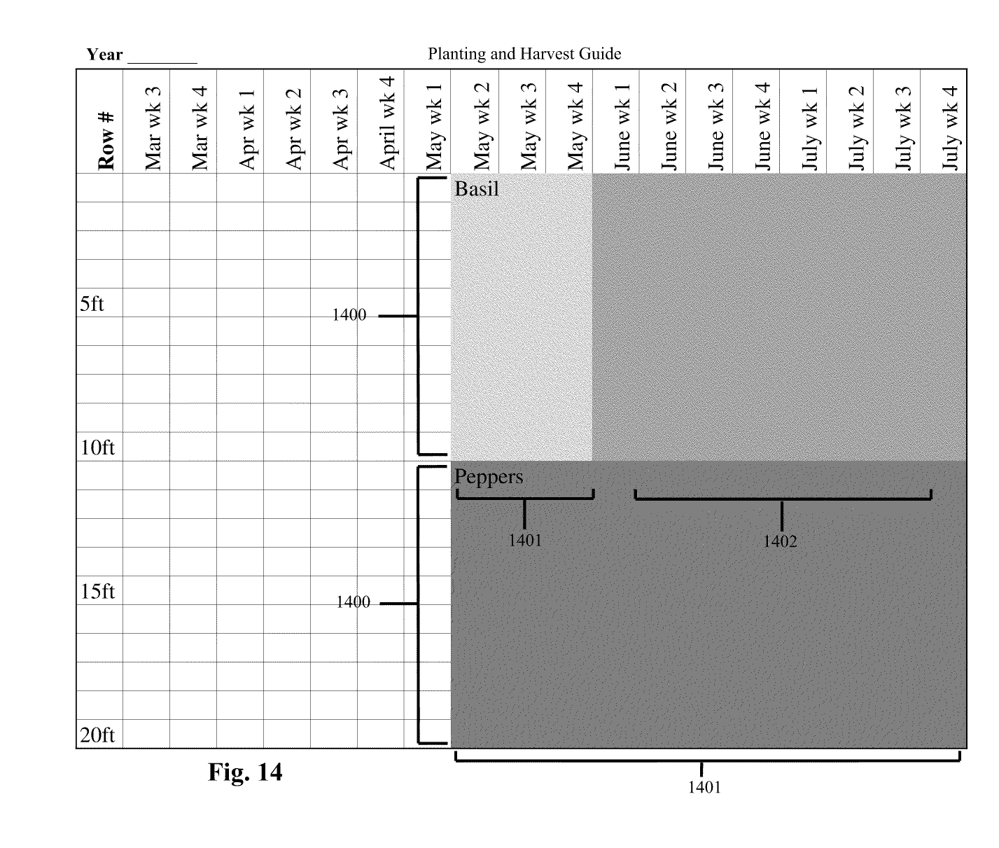

Information from the Planting Overview template shown in FIG. 12 is used along with output information for the initial planting dates shown in FIG. 8 (referred to as the Cold Weather Planting and Harvest Date Info on the screen), and output information for the initial planting dates shown in FIG. 9 (referred to as the Hot Weather Planting and Harvest Date Info on the screen), and with output information for the amount of space planted for each crop shown in FIG. 6, (referred to as Hot Weather Crop Row Planting Info in the screen), and the amount of space planted for each crop per week shown in FIG. 7 (referred to as Cold Weather Crop Row Planting Info in the screen) to automatically, or manually by the user, fill in the Planting and Harvest Guide Template, shown in FIG. 13 and FIG. 14 for all crops.

Crop name 1200, row information 1201, and planting date information 1204 on the Planting Overview FIG. 12 is used to automatically or manually record on the Planting and Harvest Guide Template for both crops that are and are not succession planted, the designation of the Row 1300, and the crop name 1301, in the field at the intersection of the planting date 1303 and the location in the row where the crop will be planted.

For all crops that are succession planted the amount of space planted per week 702 in the screen in FIG. 7 is used to determine how much of the row is planted on the Planting and Harvest Guide Template 1302, 20 feet in the case illustrated in FIG. 13. Then the harvest date information 802 shown in FIG. 8 is used to automatically or manually shade the area that represents the maturation time 1304, and the harvest 1305. This procedure is used for all successions in both the early part of the season and later part of the season, for each crop that is succession planted until all rows for these types of crops are filled in from the Crop Rotations illustrated in FIG. 11.

The same procedure is used for all crops that are not succession planted using the amount of space planted for the entire season 601 in the screen in FIG. 6 to determine how much of the row is planted on the Planting and Harvest Guide Template 1400. Then the harvest date information 901 shown in FIG. 9 is used to automatically or manually shade the area that represents maturation time 1401. Crops that are not succession planted have continuous harvests over a period of time. The difference between the first harvest date 901 and the final harvest date 902 shown in FIG. 9 is used to shade in the harvest period 1402. This procedure is used for each crop that is not succession planted until all rows for these types of crops are filled in from the Crop Rotations illustrated in FIG. 11.

Once the templates shown in FIG. 12, FIG. 13 and FIG. 14 are completed they can be printed and used at the actual garden or farm plot to implement, “on the ground,” the plans formulated by the user using the illustrated system.

Any or all of the above noted outputs may be provided in tables and/or documents that are sent to the user. However, the distributed architecture noted above in relation to FIG. 1 also provides the ability to maintain some or all of the data/documentation at a remote location from the user. That is, the inputs as well as the generated outputs may be stored on a user file at the server 28 or other remote storage location. In addition, the storage of this information at the server or other remote storage location allows for providing updated information to the requesting user. For instance, the server may provide each user a weekly update of planting and/or harvesting tasks. For instance, each user may receive a weekly or even daily email that identifies the crops that need to be planted and/or harvested. In this regard, the requesting user may receive such emails or such emails may be provided to one or more care takers, for example, employed by the user. Accordingly, in various embodiments, such weekly/daily updates may be part of a paid service that is provided in conjunction with use of the online calculation system.

Additionally, by storing some or all of the data/documentation at a remote location (e.g., server 28), further functionality may be implemented. Specifically, users may be encouraged to provide actual results back to the system. In this regard, users may provide actual results back to the utility such that these actual results may be utilized to subsequently adjust estimated yields or for other research purposes. As will be appreciated, such actual results may be categorized into different geographic regions and/or skills levels. In any case, over time it is believed that the accumulation of the actual results from the users of the system will provide more accurate estimation for crop yields.

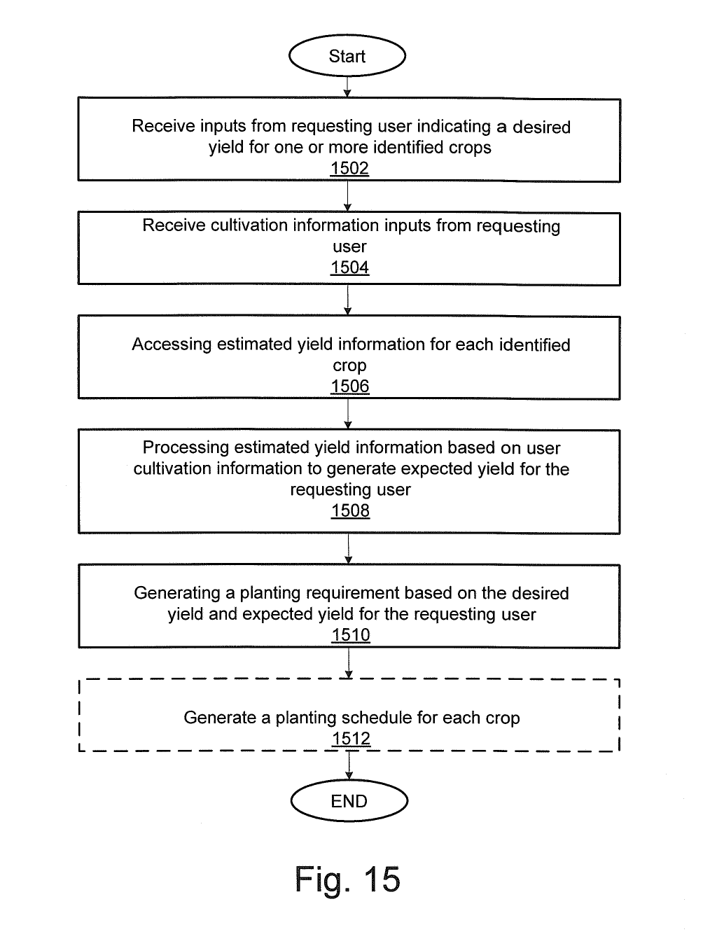

FIG. 15 illustrates one process that may be implemented by the utility of FIG. 1 in conjunction with the receipt of various user inputs. As shown, the process 1500 starts by receiving user input indicating a desired yield for one or more crops 1502. In addition, the process includes receiving cultivation information regarding the requesting user 1504. Such cultivation information may include the skill level and/or agricultural method implemented by the user. For each crop identified by the user, the process includes accessing 1506 estimated yield information for the identified crop. Once such estimated information is available, this information may be adjusted 1508 based on the user inputs to generate an expected yield for the requesting user 1508. As may be appreciated, such expected yield for the requesting user may be greater or less than the expected yield information. In addition, further aspects include accessing additional information to further adjust the estimated yield information. Such information may include, accessing geographic databases to identify geographic information (e.g. soil) and/or precipitation information. In any case, once the expected yield for the requesting user is generated, a planting requirement may be calculated 1510 using the expected yield of the requesting user in conjunction with the desired yield. Accordingly, the planning requirement (e.g. row feet, number of plants, number of weight of seeds, etc.) may be included in a planting schedule 1510 that includes one or more planting dates for the identified crops.

In another process, the utility allows for identifying user desired yields in relation to available space and iteratively adjusting the yield of one or more crops in order to fit planting requirements into available space. In this process 1600 user inputs are received 1602 identifying desired yields for one or more crops. Optionally, cultivation information regarding the user and/or cultivation methods may also be received 1604. Cultivation area information is also received 1606 which may identify the size of the cultivation area in which the requesting user will be generating the desired crops. Based on the desired crops, the process includes accessing estimated yield information for each crop 1608. Based on the desired yield and estimated yield (e.g., production per plant, production per area unit, etc.) the process determines a planting requirement to achieve the desired yields 1610. The determination 1612 is then made to identify if the available cultivation area is greater than the planting area requirements. If so, the process may generate a planning schedule 1614 that includes planting area requirements and/or planting and harvesting dates. If the cultivation area is not larger than the planting requirement area, the process 1600 may iterate and adjust the desired yields to fit the available cultivation area. Such adjustments 1616 may be automated where the process, for example, reduces the yield of all desired crops proportionally until the planting requirement area is equal to the cultivation area. Alternatively, the user may be prompted to reduce the desired yield for one or more crops until the planting area requirement is less than or equal to the cultivation area. It will be appreciated that different planting systems may utilize different area calculations. In one particular embodiment, row length measurements are provided. In this regard, it has been determined that the planting of a particular length and a row is typically easier to implement than planning a predetermined number of plants or seeds.

While various embodiments of the presented inventions have been described in detail, it is apparent that further modifications and adaptations of the invention will occur to those skilled in the art. However, it is to be expressly understood that such modifications and adaptations are within the spirit and scope of the presented inventions.

1. A web-based computer implemented method for generating crop planting and harvesting dates, comprising:
receiving, via a network interface, inputs directed to at least:
cultivation information of a requesting user;
identification of a plurality of crops to be raised in a cultivation area;
a desired crop yield for each of said plurality of crops;
accessing a crop yield database to obtain expected crop yield information for each of said plurality of crops;
processing said crop yield information in conjunction with said inputs to produce a planting plan including at least:
a schedule for planting each of said plurality of crops;
a planting requirement for generating the desired crop yield for each of said plurality of crops; and
transmitting said planting plan via a network interface, wherein said planting plan is transmitted to a client computer via a data network.

2. The method of claim 1, wherein said planting schedule includes at least a first planting date for each of said plurality of crops and at least one harvest date for each of said plurality of crops.

3. The method of claim 2, wherein said planting date is based at least in part on one of:
a last expected frost date for a geographical region associated with said requesting user; and
a maturity duration for a specific one of said plurality of crops.

4. The method of claim 3, wherein at least one of said frost date and said maturation duration are inputs provided by the requesting user.

5. The method of claim 2, wherein said planting schedule comprises a schedule for succession planting a second crop in space previously occupied by a first crop after said first crop is harvested.

6. The method of claim 1, wherein said planting requirement comprises at least one of:
a number of plants of each of said plurality of crops to generate said desired crop yield for each of said plurality of crops;
a row length of plants of each of said plurality of crops to generate said desired crop yield for each of said plurality of crops; and
a number of seeds of each of said plurality of crops to generate said desired crop yield for each of said plurality of crops.
a weight of seeds for each of said plurality of crops to generate said desired crop yield for each of said plurality of crops.

7. The method of claim 1, wherein processing said inputs comprises modifying said crop yield information based on said cultivation information of the requesting user, wherein adjustments to said crop yield information affect the planting requirement for generating said desired crop yield for each of said plurality of crops.

8. The method of claim 7, further comprising:
obtaining an geographic input from said requesting user;
based on said geographic input, accessing at least one database to obtain information for a geographic area associated with said cultivation area to obtain at least one of:
frost date information for said geographic area;
soil information for said geographic area; and
climate information for said geographic area.

9. The method of claim 8, further comprising:
modifying said crop yield information based on said geographic information, wherein adjustments to said crop yield information affect the planting requirement for generating said desired crop yield for each of said plurality of crops.

10. The method of claim 1, wherein said cultivation information comprises at least one of:
a skill level of the requesting user; and
an agricultural method incorporated by the requesting user.

11. The method of claim 1, wherein said desired yield comprises
a desired number of harvests for each of said plurality of crops, wherein said planting schedule comprises different planting dates for each harvest of each of said plurality of crops.

12. The method of claim 1, further comprising:
receiving an input of a size of a cultivation area;
determining space requirements versus desired yield and generating an output indicating that space is available and that space is not available to achieve said desired yield of each of said plurality of crops.

13. The method of claim 12, wherein upon determining that space is not available, further comprising:
adjusting a desired yield of at least one said plurality of crops to fit to said cultivation area; and
generating an output indicative of available yield based on said size of said cultivation area.

14. The method of claim 13, further comprising:
adjusting desired yields of two or more crops to fit said cultivation area.

15. The method of claim 1, further comprising
prior to at least one of a planting date and a harvesting date of said planting plan, sending a user associated with the planting plan a message via said data network, wherein said message includes at least one an identification of at least one crop and a date for planting or harvesting the at least one crop.

16. The method of claim 1, wherein said desired crop yield comprises at least one of:
a weight measure of each of said plurality of crops; and
a number of people to feed each of said plurality of crops.

17. The method of claim 1, wherein said planting plan further comprise:
a harvest date for each of said plurality of crops.

18. A web-based computer implemented method for generating crop planting and harvesting dates, comprising:
receiving, via a network interface, inputs directed to at least:
cultivation information of a requesting user;
identification of each of said plurality of crops and desired yields for each of said plurality of crops;
accessing a crop yield database to obtain expected crop yield information for said crops;
processing said crop yield information in conjunction with said inputs to produce a planting plan including at least:
a schedule for planting said crops; and
a row length planting requirement for each of said plurality of crops to generate the desired crop yield for each of said plurality of crops; and
transmitting said planting plan via a network interface, wherein said planting plan is transmitted to a client computer via a data network.

19. The method of claim 18, further comprising:
receiving an input of a total row length of cultivation rows defining a cultivation area.

20. The method of claim 19, further comprising:
comparing row length planting requirements versus total row length and generating an output indicating that space is available and that space is not available to achieve said desired yields of each of said plurality of crops.

21. The method of claim 20, wherein upon determining that space is not available, further comprising:
adjusting a desired yield of said at least one crop to match a total row length planting requirement of said crops with said total row length.

22. The method of claim 21, further comprising:
generating an output indicative of available yield of said at least one crop after adjusting said desired yield of said crop.

23. The method of claim 21, further comprising:
adjusting the desired yield of all crops to maximize the yield of each crop.

24. The method of claim 19, further comprising:
receiving row length information for a plurality of said cultivation rows wherein said planting schedule provides planting location by crop by row.

25. The method of claim 24, further comprising:
accessing stored data regarding crops previously planted in said plurality of rows;
providing an output indicative of compatibility of a crop with a previous crop planted in the same location.

26. The method of claim 18, wherein said cultivation information comprises at least one of:
a skill level of the requesting user; and
an agricultural planting method incorporated by the requesting user.
